(19) United States
(12) Patent Application Publication
(10) Pub. No.: US 2024/0408540 A1
(43) Pub. Date: Dec. 12, 2024

(54) Process Gas Preparation Device and Procedure for Preparing Process Gas

(71) Applicant: Glatt Gesellschaft mit beschränkter Haftung, Binzen (DE)

(72) Inventor: Jochen Thies, Lörrach (DE)

(21) Appl. No.: 18/690,478

(22) PCT Filed: Aug. 11, 2022
(86) PCT No.: PCT/EP2022/072602

§ 371 Date: Mar. 8, 2024

(30) Foreign Application Priority Data
Sep. 9, 2021 (DE) 10 2021 209 960.2

(51) Int. Cl. B01D 53/26; B01D 53/04

(52) U.S. Cl. CPC B01D 53/261; B01D 53/0454; B01D 53/265; B01D 2259/40009

(57) ABSTRACT

A process gas preparation device for a process gas for treating a process material in a process apparatus and a procedure for preparing process gas to treat a process material in a process apparatus during a drying phase and a cooling phase. The device includes a process gas dehumidifier and a relative humidity sensor to measure the relative humidity of the process gas arranged upstream of the process gas dehumidifier.

### CROSS-REFERENCE TO RELATED APPLICATIONS

This application is the United States national phase of International Application No. PCT/EP2022/072602 filed Aug. 11, 2022, and claims priority to German Patent Application No. 10 2021 209 960.2 filed Sep. 9, 2021, the disclosures of which are hereby incorporated by reference in their entireties.

### BACKGROUND

### Field

The invention relates to a process gas preparation device for a process gas to treat a process material in a process apparatus with a process gas inlet and a process gas outlet fluidly connected with the process device, whereby the process gas flows in a preparation section that extends from the process gas inlet to the process gas outlet, with a process gas dehumidifier designed as a device component in the flow direction of the process gas, and a process gas tempering device designed as a device component downstream from the process gas dehumidifier, whereby the process gas dehumidifier has a dehumidifier inlet and dehumidifier outlet, and the process gas tempering device has a tempering device inlet and a tempering device outlet, and whereby the process gas tempering device has a tempering unit for the process gas designed as a device component having a tempering unit inlet and a tempering unit outlet, and with a control unit.

In addition, the invention relates to a procedure for preparing process gas to treat a process material in a process device during a drying phase and a cooling phase having a process gas preparation device, with a process gas inlet and a process gas outlet fluidly connected with the process device, whereby the process gas streams in a preparation section that extends from the process gas inlet to the process gas outlet, with a process gas dehumidifier designed as a device component in the flow direction of the process gas, and a process gas tempering device designed as a device component downstream from the process gas dehumidifier, whereby the process gas dehumidifier has a dehumidifier inlet and dehumidifier outlet, and the process gas tempering device has a tempering device inlet and a tempering device outlet, and whereby the process gas tempering device has a tempering unit for the process gas designed as a device component having a tempering unit inlet and a tempering unit outlet, and with a control unit.

### Description of Related Art

Process gas preparation devices are known; however, they have long cooling times for the process gas in addition to high energy consumption.

### SUMMARY

The task of the invention therefore is to provide a process gas preparation device and a procedure for preparing process gas in order to minimize the disadvantages of known process gas preparation devices, in particular the high energy consumption.

This task is accomplished with a process gas preparation device of the type above in that a second measurement device that has a relative humidity sensor to measure the relative humidity of the process gas is arranged upstream of the process gas preparation device. Advantageously, by means of the second measurement device the relative humidity of the process gas at the measurement gas inlet is measured and transmitted to the control unit as a sensor signal. This enables a control of each device component independent of another device individual component.

In a further embodiment of the process gas preparation device in this regard, the process gas preparation device has a process apparatus designed as a device component that for practical purposes is designed as a fluidization apparatus or as a coating apparatus. Fluidization apparatuses are designed, for example, as fluidized bed apparatuses or jet bed apparatuses. Coating apparatuses are, for example, coaters, especially drum coaters.

Preferably, the process gas preparation device has a process gas conveyance device designed as a device component. The advantage of a process gas preparation device with an arrangement of this sort is that the process gas is adjustable from the process gas conveyance device, in particular a blower, a vacuum pump, or similar, to the preparation section. In this regard for practical purposes, the process gas conveyance device is arranged upstream and/or downstream of the process apparatus.

According to a further development of the process gas preparation device, the process gas dehumidifier has a condenser dehumidifier designed as a device component, having a condenser dehumidifier inlet and a condenser dehumidifier outlet, and/or has an adsorber dehumidifier designed as a device component, having an adsorber dehumidifier inlet and an adsorber dehumidifier outlet. Advantageously, the condenser dehumidifier and adsorber dehumidifier are both suited to dehumidifying process gas, whereby the use of the condenser dehumidifier and adsorber dehumidifier in the process gas dehumidifier enables an improved and precisely adjustable dehumidification of the process gas. The two device components or a combination thereof are used depending on the amount of moisture to be removed from the process gas.

For practical purposes, the condenser dehumidifier is designed as a fluid-cooled condenser, whereby cooling water, for example, from a water source in the nearby surrounding area, is used, in particular, as the fluid. The condenser dehumidifier designed as a condenser is dimensioned preferably such that the process gas can be cooled to approximately 8° C. when using cooling water. This lowers the relative humidity of the process gas, which causes it to dry.

The condenser dehumidifier designed as a condenser is sufficiently dimensioned for a majority of the procedure for preparing process gas.

When the process gas dehumidifier has a condenser dehumidifier and an adsorber dehumidifier, on the preparation section for practical purposes the condenser dehumidifier is arranged upstream of the adsorber dehumidifier. In this manner, after flowing through the condenser dehumidifier the relative humidity of the process gas can be adjusted precisely by the adsorber dehumidifier, whereby the adsorber dehumidifier is preferably designed as a desiccant wheel.

In particular, the adsorber dehumidifier has a regeneration unit designed as a device component, having a regeneration unit inlet and a regeneration unit outlet, whereby a regeneration gas is conveyed by a regeneration gas conveyance device designed as a device component, having a regeneration gas conveyance device inlet and a regeneration gas conveyance device outlet on a regeneration section extending from the regeneration unit inlet to the regeneration unit outlet, and flows through a regeneration gas heater designed as a device component, having a regeneration gas heater inlet and regeneration gas heater outlet, and an adsorber dehumidifier having a regeneration gas inlet and a regeneration gas outlet, in the flow direction of the regeneration gas. For practical purposes, the adsorber dehumidifier provides thermal regeneration. During thermal regeneration, for the regeneration of a desiccant of the adsorber dehumidifier, the regeneration gas is heated to a temperature of, for example, 160° C. or higher and is conducted through the adsorber dehumidifier to be regenerated. The hot regeneration gas extracts the moisture adsorbed from the process gas from the desiccant and preferably releases it into the environment at the regeneration unit outlet. In this regard, designing the regeneration section as a closed loop is preferable. Accordingly, this type of closed loop has the advantage that a regeneration of the adsorber dehumidifier can take place regardless of ambient conditions, i.e., without the intake of ambient air, for example.

According to a further embodiment of the process gas preparation device, the process gas dehumidifier has a preheating unit designed as a device component, having a preheating unit inlet and a preheating unit outlet, which is arranged for practical purposes of the condenser dehumidifier and/or the adsorber dehumidifier. The preheating unit is used in particular as “antifreeze heating” for the condenser dehumidifier. In the case that the regeneration section is designed as a closed loop, the moisture absorbed from the regeneration gas is condensed out in the preheating unit during the regeneration of the adsorber dehumidifier.

It is particularly preferable for the preheating unit to be assigned to the regeneration unit, whereby the preheating unit is arranged upstream of the regeneration gas heating device and downstream of the regeneration gas conveyance device on the regeneration section designed as a closed loop, whereby the process gas is heated when flowing through the preheating unit and the regeneration gas is cooled when flowing through the preheating unit. Additionally, the integration of the preheating unit designed as a thermal source increases the efficiency of process gas drying.

It is additionally preferable for the regeneration conveyance device to be arranged downstream of the adsorber dehumidifier. This arrangement of the regeneration gas conveyance device generates a preferred negative pressure on the regeneration section.

It is further preferred that the first measurement device be arranged upstream of the process gas tempering device. Advantageously, by means of the first measurement device the relative humidity in the process gas is measured and transmitted to the control unit as a sensor signal.

The moisture indicates the percentage of water vapor in the process gas, liquid water (e.g., rain, dew) does not count. The relative humidity indicates the percentage of highest possible saturation, where 100% means no additional water vapor can be absorbed in the process gas. The absolute humidity indicates the mass of water vapor per cubic meter of process gas. The higher the temperature, the more water vapor the process gas, especially air, can hold.

The relative humidity can be converted to absolute humidity using approximation formulas. Various approximation formulas in this regard are known from the literature. A “simple” approximation formula for calculating absolute humidity f in unit g/m³ from the relative humidity and temperature.

$$f = \frac{6.112 \cdot {e}^{\frac{( 17.67 \times T )}{( T + 243.5 )}} \cdot rh \cdot 18.02}{( 273.15 + T ) \cdot 100 \cdot 0.08314}$$

achieves a precision with a deviation of 0.1% in the temperature range of −30° C. and 35° C. and normal atmospheric pressure, where in the formula the temperature T is specified in degrees Celsius, the relative humidity rh is specified in %, and e is the base of natural logarithm 2.71828. The more the temperature deviates from the specified temperature range, the less precise the result of the conversion.

The process gas temperature is required to convert absolute humidity to relative humidity. For this reason, the first measurement device additionally has a temperature sensor to measure the process gas temperature. For practical purposes the process gas is also measured and transmitted to the control unit as a sensor signal.

The relative humidity sensor and temperature sensor of the first measurement device are preferably designed as an integrated unit.

Using the temperature transmitted to the control unit as a sensor signal for practical purposes and the relative humidity of the process gas enables the calculation of the absolute humidity that is independent of the temperature. The conversion to the absolute humidity actual value takes place in the first measurement unit or in the control unit.

According to another further embodiment of the process gas preparation device, the tempering unit has a heating device designed as a device component, having a heating device inlet and a heating device outlet. The heating device is advantageously suited to prepare the process gas in the drying phase of treating the process material through cooling or warming. Thus, any temperature of the process gas, in particular in the form of ambient air, can be set within a range from 5° C. to 250° C.

According to an additional further development of the process gas preparation device, the process gas conveyance device is arranged downstream of the process gas dehumidifier and upstream of the process gas tempering device. This arrangement of the process gas conveyance device downstream of the process gas dehumidifier generates a preferred negative pressure on the preparation section.

Additionally, in a further embodiment of the process gas preparation device, the process gas tempering unit has a cooling unit for the process gas designed as a device component, having a cooling unit inlet and a cooling unit outlet, and has a bypass unit designed as a device component, having a bypass inlet and a bypass outlet, connected parallel to the tempering unit, whereby a valve arrangement designed as a device component is arranged on the bypass unit for selective flow through the tempering unit or the bypass unit, and is connected to a first measurement device having a relative humidity sensor for measuring the relative humidity of the process gas, whereby the first measurement device is arranged downstream of the process gas dehumidifier. The cooling unit as a component of the bypass unit is preferred here. In addition to the advantage of a significantly reduced energy consumption during the drying phase and cooling phase of the process material, a process gas preparation device of this sort has the advantage that the cooling times for the process gas, which is designed in particular as ambient air, can be reduced in the cooling phase of the process material that follows the drying phase through the arrangement of the cooling unit in the bypass unit. A cooling phase of the process material begins after the drying phase of the process material. The cooling phase is necessary to prevent a “sweating out” of moisture, especially in the form of water, from the treated process material, because this moisture can otherwise condense, resulting in an unwanted agglomeration of the process material in the process apparatus. In the known process gas preparation devices, a cooling of the process gas takes place upstream or downstream of the process gas tempering device. In the case of process gas cooling taking place upstream or downstream of the process gas tempering device, flow goes through all device components even during the cooling phase, thereby taking place before the process material cools, which, e.g., requires a lot of energy and time because of the inert mass of the installed device components.

The process gas temperature is required to convert absolute humidity to relative humidity. For this reason, the second measurement device additionally has a temperature sensor to measure the process gas temperature. In particular, the temperature of the process gas measured on the second measurement device is transmitted as a sensor signal to the control unit.

The relative humidity sensor and temperature sensor of the second measurement device are also designed for practical purposes as an integrated unit.

The temperature and relative humidity measured on the second measurement unit are used to regulate and/or control the individual device components in the form of being switched on and/or being switched off. In particular, the condenser dehumidifier, the adsorber dehumidifier, the preheating unit, and/or the humidifier are regulated and/or controlled accordingly in such a manner. Surprisingly, this contemporary, innovative, and proactive control technology results in enormous energy savings and improved preparation of the process gas.

In a further embodiment of the process gas preparation device, it preferably has a humidifier designed as a device component, having a humidifier inlet and humidifier outlet, arranged in particular downstream of the process gas dehumidifier and upstream of the process gas tempering device. The humidifier makes it possible to humidify the process gas and also to set the moisture of the process gas so that the amount is higher than the moisture of the process gas entering the process gas inlet in the process gas preparation device. For this, the process gas is heated by the preheating unit to a temperature that enables the process gas to absorb moisture.

In addition, for the procedure of the type above the task is accomplished in that each device component of the process gas preparation device can be switched on and/or switched off. For this, a second measurement device is arranged upstream of the process gas dehumidifier, having a relative humidity sensor to measure the relative humidity of the process gas and a temperature sensor to measure the temperature of the process gas, and in the control unit a second absolute humidity comparison takes place between the absolute humidity nominal value and the absolute humidity actual value, whereby the absolute humidity actual value is determined from a relative humidity value measured by a relative humidity sensor of the second measurement device, and a measurement value from the corresponding temperature sensor. For practical purposes, the absolute humidity actual value determination takes place in the second measurement unit or in the control unit. The control unit, taking into account the second absolute humidity comparison, can transmit an absolute humidity variable to each device component in order to switch on and/or switch off the corresponding device component.

According to another advantageous embodiment of the procedure, the humidity of the process gas flowing through the process gas preparation device is regulated, in particular at least during the drying phase. The humidity of the process gas can be regulated both by means of the relative humidity and by means of absolute humidity, whereby regulation by means of absolute humidity is preferable because the absolute humidity, in contrast to the relative humidity, is independent of the temperature of the process gas.

Preferably for this, the first measurement device has a temperature sensor to measure the temperature of the process gas, and in the control unit a first absolute humidity comparison takes place between the absolute humidity nominal value and the absolute humidity actual value, whereby the absolute humidity actual value is determined from a relative humidity value measured by a relative humidity sensor of the first measurement device, and a measurement value from the corresponding temperature sensor. For practical purposes, the absolute humidity actual value determination takes place in the first measurement unit or in the control unit. The control unit, taking account the first absolute humidity into comparison, can transmit an absolute humidity variable to the process gas dehumidifier and/or humidifier in order to regulate the absolute humidity of the process gas. For practical purposes, the humidity is regulated in a tolerance range of +3% of the nominal value.

In this regard the process gas is humidified by a humidifier arranged in particular downstream of the process gas dehumidifier and upstream of the process gas tempering device. The humidifier makes it possible to humidify the process gas and also to set the moisture of the process gas so that the amount is higher than the moisture of the process gas entering the process gas inlet in the process gas preparation device. For this, the process gas is heated by the preheating unit to a temperature that enables the process gas to absorb moisture. By means of the humidifier, the procedure to prepare process gas for the treatment of a process material in a process apparatus, in particular of a fluidization apparatus or a coating apparatus, is made even more flexible.

According to a further embodiment of the procedure, the process gas dehumidifier has an adsorber dehumidifier that has a regeneration unit, whereby the adsorber dehumidifier is at least partially regenerated by the regeneration unit. In this regard the regeneration unit has a regeneration gas heating device warming a regeneration gas, so that the regeneration gas absorbs moisture when flowing through the adsorber dehumidifier, through which the adsorber dehumidifier is at least partially dried and thereby regenerated. The adsorber dehumidifier dehumidifies the process gas, regardless whether or not there is an upstream condenser dehumidifier, so that the nominal value stored in the control unit is always reached. This is achieved in particular through an exact setting of the parameters important for this, such as temperature and relative humidity of the regeneration gas. Thus, the control unit in particular regulates and/or controls the regeneration gas heating device due to the comparison of actual value and nominal value. The regeneration gas regenerates the adsorber dehumidifier such that it can take on the exact volume of moisture in order to dry the process gas accordingly to achieve the nominal value saved in the control unit. Preferably the regeneration gas flows through the adsorber dehumidifier in a reverse flow to the process gas.

Furthermore, the process gas dehumidifier has a preheating unit that for practical purposes of is arranged upstream the condenser dehumidifier, whereby the preheating unit warms the process gas entering the process gas preparation device via the process gas inlet, in order to prevent freezing of the condenser dehumidifier or to warm the process gas for the humidifying of the process gas. The preheating unit is used in particular as “antifreeze heating” for the condenser dehumidifier. In the case that the regeneration section is designed as a closed loop, the moisture absorbed from the regeneration gas is condensed out in the preheating unit during the regeneration of the adsorber dehumidifier.

According to a further embodiment of the procedure, the process gas tempering unit has a cooling unit for the process gas designed as a device component, having a cooling unit inlet and a cooling unit outlet, and has a bypass unit designed as a device component, having a bypass inlet and a bypass outlet, connected parallel to the tempering unit, whereby a valve arrangement designed as a device component is arranged on the bypass unit for selective flow through the tempering unit or the bypass unit, and is connected to a first measurement device having a relative humidity sensor for measuring the relative humidity of the process gas, w whereby the first measurement device is arranged downstream of the process gas dehumidifier, whereby the cooling unit is a component of the bypass unit, and whereby during treatment of the process material in the process apparatus there is flow through the tempering unit in the drying phase and through the bypass unit that has the cooling unit during the cooling phase. A procedure designed in this manner for the preparation of process gas in a process gas preparation device, in addition to the advantage of a significantly reduced energy consumption during the drying phase and cooling phase of the process material, has the advantage that the cooling times for the process gas, which is designed in particular as ambient air, can be reduced in the cooling phase of the process material that follows the drying phase by means of the arrangement of the cooling unit in the bypass unit. A cooling phase of the process material begins after the drying phase of the process material. The cooling phase is necessary to prevent a “sweating out” of moisture, especially in the form of water, from the treated process material, because this moisture can otherwise condense, resulting in an unwanted agglomeration of the process material in the process apparatus. In the known process gas preparation devices, a cooling of the process gas takes place upstream or downstream of the process gas tempering device. In the case of process gas cooling taking place upstream or downstream of the process gas tempering device, flow goes through all device components even during the cooling phase, thereby taking place before the process material cools, which, e.g., requires a lot of energy and time because of the inert mass of the installed device components. With the procedure, there is no flow through the process gas tempering device during the cooling phase, which makes the procedure significantly more energy efficient than the procedures already known.

The control unit decides which device components of the process gas preparation device to switch on or switch off to dehumidify the process gas, based on the absolute humidity comparison. The following presents absolute humidity nominal values used in practice when operating the process gas preparation device:
Dehumidification only via the condenser dehumidifier at an absolute humidity nominal value of greater than or equal to 8 g/m³; adsorber dehumidifier if present switched off
Dehumidification only via the adsorber dehumidifier at an absolute humidity nominal value of less than 8 g/m³; condenser dehumidifier if present switched off
Dehumidification via the condenser dehumidifier and via the adsorber dehumidifier at an absolute humidity nominal value of less than 8 g/m³ and a difference between the absolute humidity actual value and absolute humidity nominal value of greater than or equal to 6 g/m³
Humidification via the humidifier for an absolute humidity actual value less than the absolute humidity nominal value.

The aforementioned absolute humidity nominal value is a value based on experience that can also deviate from the aforementioned absolute humidity nominal value.

The process gas preparation device has a process gas conveyance device designed as a device component that conveys the process gas on a preparation section from the process gas inlet to the process gas outlet. The advantage of the procedure with an arrangement of this sort is that the process gas is conveyed to the preparation section, adjustable by the process gas conveyance device, in particular a blower, a vacuum pump, or similar.

### BRIEF DESCRIPTION OF THE DRAWINGS

The terms Fig., Figs., Figure, and Figures are used interchangeably in the specification to refer to the corresponding figures in the drawings.

In the following the invention is described in further detail using the attached drawings, which show:

FIG. 1 is a schematic diagram of a first embodiment of a process gas preparation device;

FIG. 2 is a schematic diagram of a second embodiment of a process gas preparation device;

FIG. 3 is a schematic diagram of a third embodiment of a process gas preparation device;

FIG. 4 is a schematic diagram of a fourth embodiment of a process gas preparation device;

FIG. 5 is a schematic diagram of a fifth embodiment of a process gas preparation device;

FIG. 6 is a schematic diagram of a sixth embodiment of a process gas preparation device; and

FIG. 7 is a schematic diagram of a seventh embodiment of a process gas preparation device.

### DETAILED DESCRIPTION

Unless specified otherwise, the following description refers to all of the embodiments illustrated in the drawing for preferred process gas preparation device 1 for a process gas 2 for the treatment of a process material in a process apparatus 3 and a corresponding procedure to prepare process gas 2 for the treatment of a process material in a process apparatus 3. The process gas preparation device 1 has the process apparatus 3 for practical purposes here designed as a device component 4, designed in particular as a fluidization apparatus 5 or a coating apparatus 6.

The process gas preparation device 1 has a process gas inlet 7 and a process gas outlet 10 connected fluidly to a process apparatus 3 having a process apparatus inlet 8 and a process apparatus outlet 9. Preferably the process gas inlet 7 and process gas outlet 10 are designed as junctions at which respective supply or discharge channel sections 11, for practical purposes designed as pipes, can be arranged or are arranged. For better differentiation of objects that respectively are the same, they will be identified in the following with a, b, c, etc. added to the reference sign; for example, 11a, 11b, 11c.

The process gas 2 is conveyed by a process gas conveyance device 12 designed as a device component 4 on a preparation section 13 from the process gas inlet 7 to the process has outlet 10. The process gas conveyance device 12, having a process gas conveyance device inlet 14 and a process gas conveyance device outlet 15, is designed for practical purposes as a vacuum pump 16 or blower 17. The process gas conveyance device inlet 14 and a process gas conveyance device outlet 15 are designed as junctions to which supply or discharge channel sections 11 can be arranged or are arranged, where the channel sections 11 are designed in particular as pipes.

The process gas preparation device 1 has a process gas dehumidifier 18 designed as a device component 4 in the flow direction of the process gas 2, and a process gas tempering device 19 designed as a device component 4 arranged downstream of the process gas dehumidifier 18. Preferably, the process gas conveyance device 12 is arranged downstream of the process gas dehumidifier 18 and upstream of the process gas tempering device 19.

The process gas dehumidifier 18 has a dehumidifier inlet 20 and a dehumidifier outlet 21 and the process gas tempering device has a tempering device inlet 22 and a tempering device outlet 23. Preferably, the dehumidifier inlet 20, dehumidifier outlet 21, tempering device inlet 22, and tempering device outlet 23 are designed as junctions to which supply or discharge channel sections 11 designed in particular in the form of pipes, can be arranged or are arranged. Advantageously, the process gas dehumidifier 18 can enable a precisely adjustable dehumidification of the process gas 2.

The process gas dehumidifier 18 in this case has a condenser dehumidifier 26 designed as a device component 4, having a condenser dehumidifier inlet 24 and a condenser dehumidifier outlet 25, and/or an adsorber dehumidifier 29 designed as a device component 4, having an adsorber dehumidifier inlet 27 and an adsorber dehumidifier outlet 28. Preferably, the condenser dehumidifier inlet 24 and condenser dehumidifier outlet 25, as well as the adsorber dehumidifier inlet 27 and adsorber dehumidifier outlet 28 are designed as junctions to which supply or discharge channel sections 11 designed for practical purposes as pipes can be arranged or are arranged.

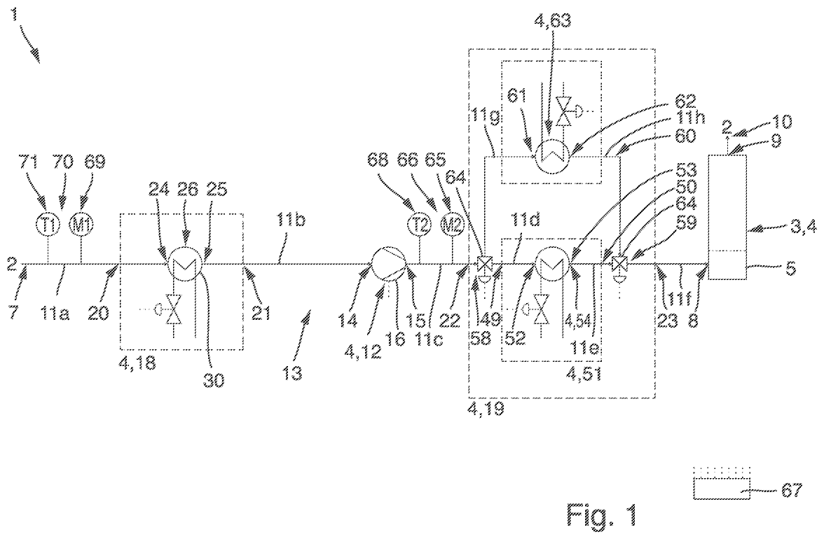

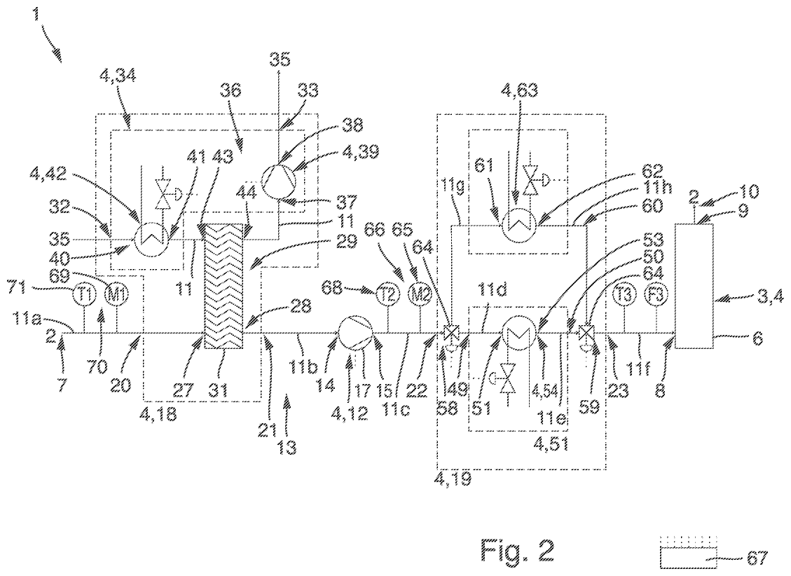

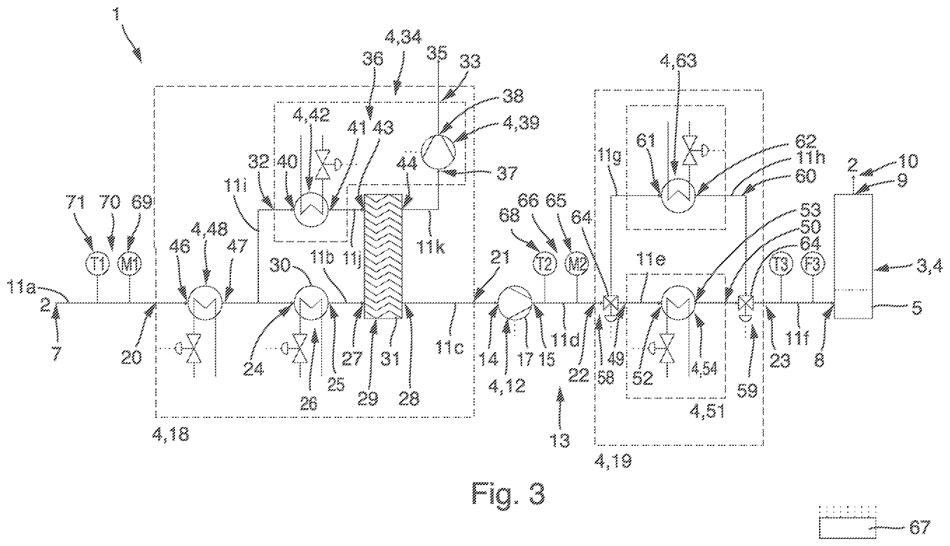

Except for the first embodiment of the process gas preparation device 1 shown in FIG. 1, in which the process gas dehumidifier 18 only has the condenser dehumidifier 26, and the embodiment shown in FIG. 2, in which the process gas dehumidifier 18 only has the adsorber dehumidifier 29, the process gas dehumidifier 18 in all other embodiments shown in FIGS. 3 through 7 each has the condenser dehumidifier 26 and the adsorber dehumidifier 29 arranged downstream of the condenser dehumidifier 26 on the preparation section 13. Preferably, the condenser dehumidifier 26 is designed as a fluid-cooled condenser 30, and the adsorber dehumidifier 29 is designed as a desiccant wheel 31.

With the fluid-cooled condenser, cooling water is used in particular as the fluid. The condenser 30 is dimensioned in particular such that, when using cooling water the process gas is cooled to approximately 8° C., whereby the humidity of the process gas decreases. A condenser of this sort is sufficiently dimensioned for a majority of the procedure for preparing process gas 2. The process gas 2 can also be cooled to another temperature. The aforementioned 8° C. is based on experience when using cooling water from the cooling water system of operators of a process gas preparation device 1.

The embodiment shown in FIG. 2 presents an adsorber dehumidifier 29 designed as a process gas dehumidifier 18 in the form of a desiccant wheel 31. Through the adsorber dehumidifier 29 designed as a desiccant wheel 31, the humidity of the process gas 2 can be set precisely.

In the embodiments of FIGS. 3 through 6 as well, through the adsorber dehumidifier 29 designed as a desiccant wheel 31, the humidity of the process gas 2 can be set precisely. In the embodiments shown in FIGS. 2 through 6, the adsorber dehumidifier 29 has a regeneration unit 34 designed as a device component 4, having a regeneration unit inlet 32 and regeneration unit outlet 33. Preferably the regeneration unit inlet 32 and regeneration unit outlet 33 are designed as junctions at which respective supply or discharge channel sections 11, for practical purposes designed as pipes, can be arranged or are arranged.

For the regeneration of the adsorber dehumidifier 29, in particular the desiccant wheel 31, a regeneration gas 35 is conveyed on a regeneration section 36 extending from the regeneration unit inlet 32 to the regeneration unit outlet 33 on a regeneration gas conveyance device 39 designed as a device component 4, having a regeneration gas conveyance device inlet 37 and a regeneration gas conveyance device outlet 38. For practical purposes, the regeneration gas conveyance device inlet 37 and regeneration gas conveyance device outlet 38 are designed as junctions at which respective supply or discharge channel sections 11, for example, designed as pipes, can be arranged or are arranged. There is flow through a regeneration gas heating device 42 designed as a device a component 4, having regeneration gas heating device inlet 40 and a regeneration gas heating device outlet 41, and an adsorber dehumidifier 29, having a regeneration gas inlet 43 and regeneration gas outlet 44, in the flow direction of the regeneration gas 35. Heat exchangers or electric heaters are particularly suited as a regeneration gas heating device 42. Preferably, the regeneration gas heating device inlet 40 and regeneration gas heating device outlet 41, as well as the regeneration gas inlet 43 and regeneration gas outlet 44 are designed as junctions to which supply or discharge channel sections 11 designed in particular as pipes arranged or are arranged. For practical purposes, the regeneration gas conveyance device 39 on the regeneration section 36 is arranged downstream of the adsorber dehumidifier 29 and further preferred simultaneously upstream of the process gas tempering device 19, by means of which preferably a negative pressure can be generated or is generated on the regeneration section 36.

For practical purposes, the adsorber dehumidifier 29 provides thermal regeneration. During thermal regeneration, for the regeneration of a desiccant of the adsorber dehumidifier 29, the regeneration gas 35 is heated to a temperature of, for example, 160° C. or higher and is conducted through the adsorber dehumidifier 29 to be regenerated. The hot regeneration gas 35 extracts the moisture adsorbed from the process gas 2 from the desiccant and preferably releases it into the environment at the regeneration unit outlet 33.

In the embodiment shown in FIG. 3, a part of the process gas 2 is used as the regeneration gas 35, which is diverted from the process gas 2 upstream of the condenser dehumidifier 26. After diversion, the regeneration gas 35 flows in the flow direction along the regeneration section 36 through the regeneration gas heating device 36, the adsorber dehumidifier 29, and the regeneration gas conveyance device 39 via the regeneration unit outlet 33 into the environment-thereby exiting the regeneration unit 34 and therefore the process gas preparation device 1.

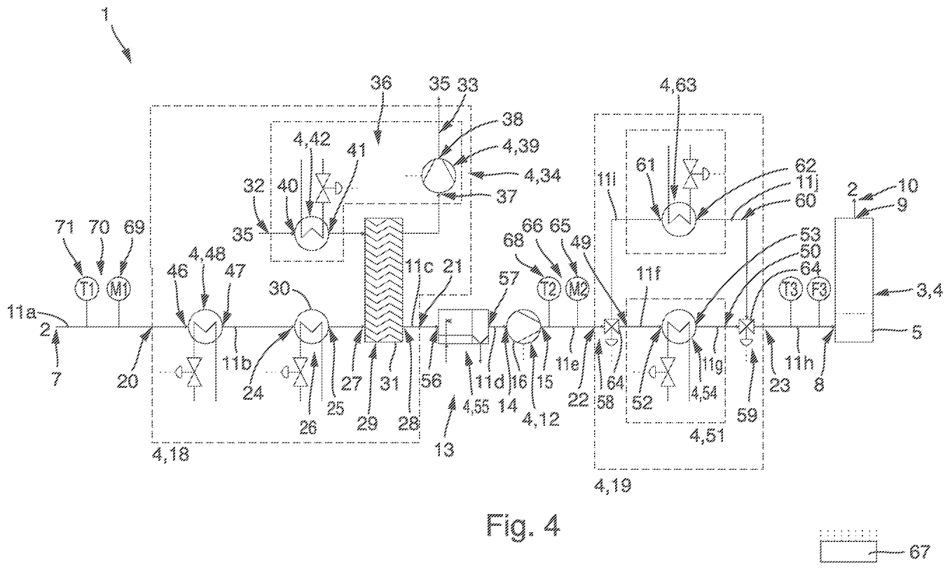

In contrast to the embodiment shown in FIG. 3, the regeneration gas 35 in the embodiments shown in FIGS. 2 and 4 is not part of the process gas 2, but is instead extracted from ambient air.

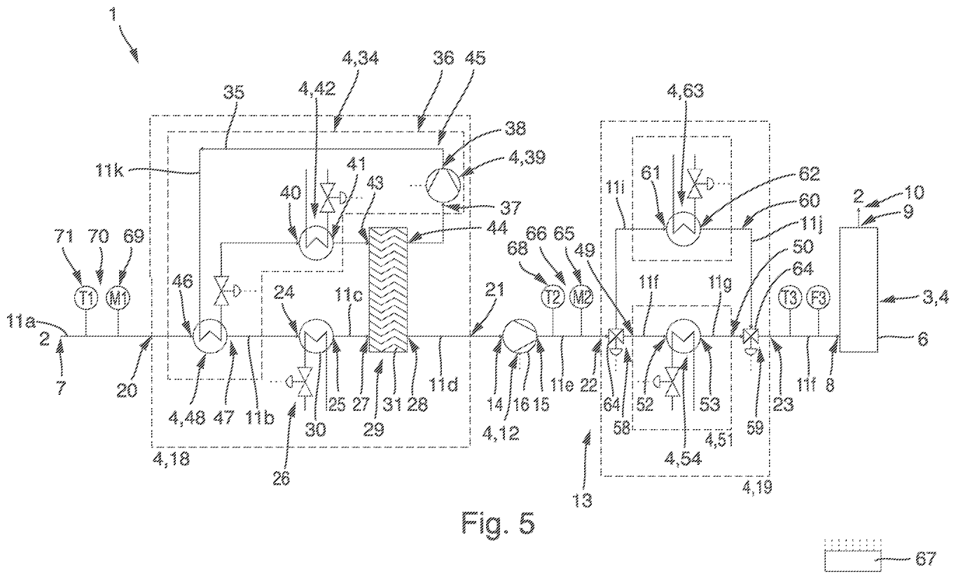

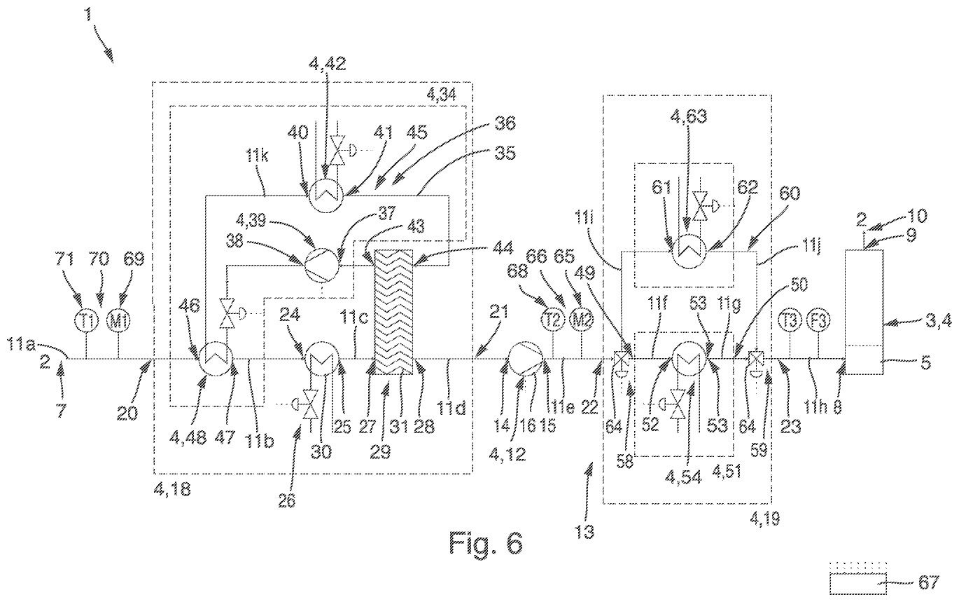

In the two embodiments described in FIGS. 5 and 6, the regeneration section 36 is designed as a closed loop 45, in contrast to the embodiments of FIGS. 2 through 4. In the fifth embodiment shown in FIG. 5, the regeneration gas 35 flows through the adsorber dehumidifier 29 in a flow parallel to the process gas 2. In the sixth embodiment shown in FIG. 6, the process gas 2 and the regeneration gas 35 flow through the adsorber dehumidifier 29 in opposite directions. A closed loop 45 has the advantage that a regeneration of the adsorber dehumidifier 29 can take place regardless of the ambient conditions, for example, regardless of the ambient temperature and ambient air.

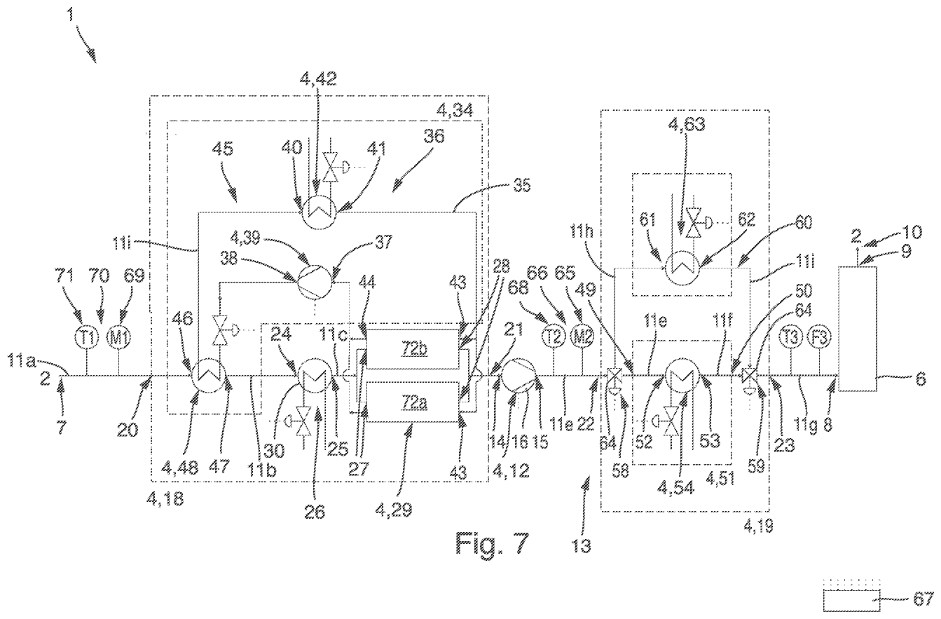

FIG. 7 shows a seventh embodiment of the process gas preparation device 1. In this case the adsorber dehumidifier 29 of the process gas dehumidifier 18 has two containers 72a and 72b, each of which is filled with adsorbent. A container 72a or 72b respectively regenerated cold or warm by means of regeneration gas 35, while process gas 2 flows through the other container 72a or 72b respectively and dries it to the humidity desired.

In addition, the process gas dehumidifier 18 has a preheating unit 48 designed as a device component 4, having a preheating unit inlet 46 and a preheating unit outlet 47. The preheating unit is used in particular as “antifreeze heating” for the condenser dehumidifier 26 and for practical purposes is arranged upstream of the condenser dehumidifier 26 and/or downstream of the adsorber dehumidifier 29. In the case that the regeneration section 36 is designed as a closed loop 45, the moisture absorbed from the regeneration gas 35 is condensed out in the preheating unit 48 during the regeneration of the adsorber dehumidifier 29. It is advantageous in this regard for the preheating unit 48 further to be assigned to the regeneration unit 34, whereby the preheating unit 48 is arranged upstream of the regeneration gas heating device 42 and downstream of the regeneration gas conveyance device 39 on the regeneration section 36 designed as a closed loop 45, whereby the process gas 2 is heated when flowing through the preheating unit 48 and the regeneration gas 35 is cooled when flowing through the preheating unit 48. For practical purposes, the preheating unit inlet 46 and preheating unit outlet 47 are designed as pipe connections at which respective supply or discharge channel sections 11, for practical purposes designed as pipes, can be arranged or are arranged.

For the process gas 2, the process gas tempering device 19 has a tempering unit 51 designed as a device component 4, having a tempering unit inlet 49 and a tempering unit outlet 50. For practical purposes, the tempering unit inlet 49 and tempering unit outlet 50 are designed as pipe connections at which respective supply or discharge channel sections 11, for practical purposes designed as pipes, can be arranged or are arranged. In this case, the tempering unit 51 has a heating device 54 designed as a device component 4, having a heating device inlet 52 and a heating device outlet 53. Preferably, also the heating device inlet 52 and heating device outlet 53 are designed as pipe connections at which respective supply or discharge channel sections 11, for practical purposes designed as pipes, can be arranged or are arranged. The heating device 54 is advantageously suited to prepare the process gas 2 in the drying phase of process material treatment through cooling or warming, in particular a temperature range of 10° C. to 250° C. can be set, preferably at a minimum above the ambient temperature.

Furthermore, the process gas preparation device 1 has a humidifier 55 designed as a device component 4, having a humidifier inlet 56 and humidifier outlet 57, arranged in particular downstream of the process gas dehumidifier 18 and upstream of the process gas tempering device 19. Preferably, also the humidifier inlet 56 and humidifier outlet 57 are designed as pipe connections at which respective supply or discharge channel sections 11, for practical purposes designed as pipes, can be arranged or are arranged. The humidifier 55 makes it possible to humidify the process gas 2 and also to set the relative humidity of the process gas 2 so that the amount is higher than that of the process gas 2 entering the process gas inlet 7 in the process gas preparation device 1.

In addition, the process gas tempering device 19 has a bypass unit 60 designed as a device component 4, having a bypass unit inlet 58 and a bypass unit outlet 59, connected parallel to the tempering unit 51. The bypass unit 60 in turn has a cooling unit 63 designed as a device component 4, having a cooling unit inlet 61 and a cooling unit outlet 62, in particular a heat exchanger or similar, for the process gas 2. Preferably, the cooling unit inlet 61 and cooling unit outlet 62 are designed as pipe connections at which respective supply or discharge channel sections 11, for practical purposes designed as pipes, can be arranged or are arranged. A valve arrangement 64 designed as a device component 4 for selective flow through the tempering unit 51 or bypass unit 60 is arranged on the bypass unit 60, whereby the cooling unit 63 is part of the bypass unit 60. The bypass unit 60 for practical purposes is designed as a channel section 11 in the form of a pipe. For practical purposes, as the valve arrangement two 3-way valves are used or another valve arrangement 64 suitable for the selective flow through the tempering unit 51 or bypass unit 60.

The process gas preparation device 1 also has a first measurement device 66, having a relative humidity sensor 65 for measuring the relative humidity of the process gas 1, whereby the first measurement device is arranged downstream of the process gas dehumidifier. By means of the relative humidity sensor 65, the relative humidity in the process gas 2 is measured and is transmitted as an actual value in the form of a sensor signal to the control unit 67. The control unit 67 is configured to regulate and/or control all device components 4 independently of one another. The respective inlets and outlets of the device components 4 corresponding to the embodiments shown in FIGS. 1 through 7 are connected to one another by means of channel sections 11, preferably in the form of pipes. The periphery arranged upstream of the process gas. 7 and downstream of the process gas outlet 10 can also be connected via channel sections 11, preferably in the form of pipes.

Furthermore, the first measurement device 66 additionally has a temperature sensor 68 to measure the temperature of the process gas 2. The temperature value is also transmitted to the control unit 67 as an actual value for the temperature, in the form of a sensor signal. For practical purposes, the relative humidity sensor and temperature sensor 68 of the first measurement device 66 are designed as an integrated unit.

From the relative humidity of the process gas measured on the relative humidity sensor 66 and the temperature measured on the temperature sensor 68—as previously explained—the absolute humidity actual value of the process gas 2 determines the absolute humidity. The absolute humidity actual value determination takes place in the first measurement unit 66 or in the control unit 67. In the case where the absolute humidity actual value determination takes place in the first measurement unit 66, the absolute humidity actual value is transmitted as a sensor signal to the control unit 67.

The humidity, preferably the absolute humidity, of the process gas 2 flowing through the process gas preparation device 1, is regulated by the control unit 67 in conjunction with the first measurement unit 66. Advantageously, the humidity is regulated at a minimum during the drying phase. The regulation is based either on the relative humidity or the absolute humidity, whereby regulation based on absolute temperature is preferred because it is independent of temperature.

In this case, in the control unit 67 a first absolute humidity comparison between an absolute humidity nominal value stored in the control unit 67 and the absolute humidity actual value takes place, whereby the absolute humidity actual value, as described, is determined from a relative humidity value measured by a relative humidity sensor 65 of the first measurement device 66, and a temperature value measured by the corresponding temperature sensor 68.

The control unit 67 in addition, taking into account the first absolute humidity comparison, transmits an absolute humidity variable to the process gas dehumidifier 18 in order to regulate the absolute humidity of the process gas 2.

There are various ways to dry to a lower humidity, whereby drying by means of the condenser humidifier 26 via cooling water is limited. The adsorber dehumidifier is limited by the capacity of the desiccant, whereby the humidity to be absorbed can be set through a regeneration of the desiccant.

The absolute humidity of the process gas 2 is set by the process gas dehumidifier 18 regulated by the control unit 67 such that the corresponding absolute humidity actual value and the absolute humidity nominal value match, for practical purposes in a tolerance range of less than or equal to 3%. The previously described applies for the relative humidity.

If during the absolute humidity comparison the absolute humidity actual value is less than the absolute humidity nominal value, the process gas 2 is humidified. In this case the process gas 2 is warmed for practical purposes by the preheating unit 48, so that the temperature of the process gas 2 enables the absorption of the supplied humidity. The humidity is subsequently supplied to the process gas by means of the humidifier 55. For practical purposes here, the first measurement device 66 is arranged upstream of the process gas tempering device 19.

In addition, there is a second measurement device 70 for the measurement of the relative humidity of the process gas 2 using a relative humidity sensor 69 that is arranged upstream of the process gas dehumidifier. By means of the relative humidity sensor 69, the relative humidity in the process gas 2 is measured and is transmitted as an additional actual value in the form of a sensor signal to the control unit 67.

The second measurement device additionally also preferably has a temperature sensor 71 for measuring the temperature of the process gas 2, whereby the relative humidity sensor 69 and the temperature sensor 71 of the second measurement device for practical purposes are designed as an integrated unit. In the case where the absolute humidity actual value determination takes place in the second measurement unit 70, the absolute humidity actual value is transmitted as a sensor signal to the control unit 67.

By means of a second regulation and/or control taking place based on the second measurement device, each device component 4 of the process gas preparation device 1 can be switched on or switched off.

For this, a second measurement device 70 is arranged upstream of the process gas dehumidifier 1, having a relative humidity sensor 69 to measure the relative humidity of the process gas 2 and a temperature sensor 71 to measure the temperature of the process gas 2, and in the control unit 67 a second absolute humidity comparison takes place between an absolute humidity nominal value stored in the control unit 67, which for practical purposes differs from the absolute humidity nominal value to regulate the humidity, and an absolute humidity actual value, whereby the absolute humidity actual value is determined from a relative humidity value measured by a relative humidity sensor 69 of the second measurement device 70, and a temperature value measured from the corresponding temperature sensor 71.

The absolute humidity actual value determination takes place preferably in the second measurement unit 70 or in the control unit 67.

The control unit 67, taking into account the second absolute humidity comparison, transmits an absolute humidity variable to each device component 4 in order to switch on and/or switch off the corresponding device component 4 of the process gas preparation device 1. This makes it possible while a procedure is running to switch on and/or switch off each individual device component, in particular, however, the condenser dehumidifier 26 and/or the adsorber dehumidifier 29 and/or the humidifier 55. Surprisingly this contemporary, innovative, and proactive regulation and/or control technology results in enormous energy savings and improved preparation of the process gas 2, in particular in view of temperature and humidity.

The regulation and/or control of the device components 4, as previously described, can be based equally on the absolute humidity and the relative humidity. The regulation and/or control here is preferably by means of absolute humidity because this is temperature independent. For practical purposes, within a tolerance range of less than 3%.

The procedure to prepare process gas 2 to treat a process material in a process apparatus 3 takes place in the process gas preparation device as explained in detail below:

The preparation of the process gas 2 to treat the process material apparatus in particular a in the process 3, fluidization device 5 or a coating device 6, is divided into two procedure phases that run in sequence, namely a drying phase and a cooling phase. At the end of each handling of the process material, there is the cooling phase of the process material. This is necessary to prevent a “sweating out” of moisture, especially in the form of water, from the treated process material, because the moisture can otherwise condense, which can result or results in an unwanted agglomeration of the process material in the process apparatus 3. For this reason during treatment of the process material in the process apparatus, during the drying phase there is flow through the tempering unit 51 of the process gas tempering device 19, and during the cooling phase there is flow through the cooling unit 63 belonging to the bypass unit 60. Flow through the tempering unit 51 means no flow through the bypass unit 60 and vice versa. The procedure for the preparation of process gas 2 in a process gas preparation device 1, in addition to the advantage of a significantly reduced energy consumption during the entire treatment of the process material, has the advantage that the cooling times for the process gas 2, which is in particular ambient air, can be reduced in the cooling phase of the process material that follows the drying phase, by means of the arrangement of the cooling unit 63 in the bypass unit 60. As a result, the process material can be cooled faster and more energy efficiently.

During treatment of the process material in the process apparatus 3, the process gas 2 enters the process gas preparation device 1 at the process gas inlet 7 and flows through this and then on to the process apparatus 3 connected to the process gas preparation device 1. The process gas 2 here is conveyed by the process gas conveyance device 12. In addition to the process gas dehumidifier 18 and the process gas tempering device 19, the process gas 2 if necessary flows through a humidifier 55 arranged in particular downstream of the process gas dehumidifier 18 and upstream of the process gas tempering device 19. The humidifier 55 enables the process gas 2 to be humidified and also the relative humidity of the process gas 2 to be set so that the amount is higher than that of the process gas 2 entering the process gas inlet in the process gas preparation device 1. If the humidifier 55 is used, for practical purposes prior to humidification the process gas 2 is warmed by the preheating unit 48 to a temperature that ensures that the process gas 2 can absorb the humidity supplied by the humidifier 55.

In the procedure, the humidity of the process gas 2 flowing through the process gas preparation device 1 is regulated, in particular at least during the drying phase. The humidity of the process gas 2 can be regulated both by means of the relative humidity and by means of absolute humidity, whereby regulation by means of absolute humidity is preferable because the absolute humidity, in contrast to the relative humidity, is independent of the temperature of the process gas 2.

Preferably here the first measurement device 66 has the relative humidity sensor 65 to measure the relative humidity of the process gas 2 and the temperature sensor 68 to measure the temperature of the process gas 2. The relative humidity value and the temperature value are transmitted to the control unit 67 as sensor signals.

In the control unit 67 a first absolute humidity comparison between a stored absolute humidity nominal value and the absolute humidity actual value takes place, whereby the absolute humidity actual value is determined from a relative humidity value measured by a relative humidity sensor 65 of the first measurement device 66, and a temperature value measured by the corresponding temperature sensor 68. The absolute humidity actual value determination takes place for practical purposes in the first measurement unit 66 or in the control unit 67. The control unit 67, taking into account the first absolute humidity comparison, transmits an absolute humidity variable to the process gas dehumidifier 18 in order to regulate the absolute humidity of the process gas 2. For practical purposes, the humidity is regulated in a tolerance range of +3% of the nominal value.

Also, humidification that has to be performed takes place via regulation by means of the first measurement device 66, as explained above.

If the process gas dehumidifier 18 has an adsorber dehumidifier 29 designed in particular as a desiccant wheel 31 to dry the process gas, then this has a regeneration unit 34 at least partially regenerating the adsorber dehumidifier 29. Process gas dehumidifiers 18 of this sort are shown in FIGS. 2 through 7.

The regeneration gas 35 flows through the regeneration gas heating 42, device which is upstream of the adsorber dehumidifier 29 and dries and warms the regeneration gas 35 so that the regeneration gas 35 can absorb humidity of the adsorber dehumidifier 29. The regeneration gas 35 is dried and warmed to an extent that the adsorber dehumidifier 29 dries or can dry the process gas 2 also streaming through the adsorber dehumidifier 29 to a set relative humidity. For this reason, in particular the control unit 67 regulates and/or controls the regeneration gas heating device 42 on the basis of the first absolute humidity comparison between the stored absolute humidity nominal value and the absolute humidity actual value. Preferably the regeneration gas 35 flows through the adsorber dehumidifier 29, as shown in FIG. 6, in a reverse flow to the process gas 2.

Furthermore, the process gas dehumidifier 18 has a preheating unit 48 that for practical purposes is arranged upstream of the condenser dehumidifier 26, whereby the preheating unit 48 warms the process gas 2 entering the process gas preparation device 1 via the process gas inlet 7, in order to prevent freezing of the condenser dehumidifier 26. The preheating unit 48 is used in particular as “antifreeze heating” for the condenser dehumidifier 26. In the case that the regeneration section 36 is designed as a closed loop 45, the humidity absorbed from the regeneration gas 35 is condensed out in the preheating unit 48 during the regeneration of the adsorber dehumidifier 29.

Each individual device component 4 of the process gas preparation device 1 can be switched on and/or switched off. For measurement device 70 for the this, there is a second measurement of the relative humidity of the process gas 2 using a relative humidity sensor 69 and for the measurement of the temperature of the process gas using a temperature sensor 71, and that is arranged upstream of the process gas dehumidifier 18. In the control unit a second absolute humidity comparison between the absolute humidity nominal value and the absolute humidity actual value of the second measurement device 70 takes place, whereby the absolute humidity actual value is determined from a relative humidity value measured by a relative humidity sensor 69 of the second measurement device 70, and a temperature value measured by the corresponding temperature sensor 71. For practical purposes, the absolute humidity actual value determination takes place in the second measurement unit 70 or in the control unit 67. For this the control unit 67, taking into account the second absolute humidity comparison, transmits an absolute humidity variable to each device component 4 in order to switch on and/or switch off the corresponding device component 4 of the process gas preparation device 1. Surprisingly, this contemporary, innovative, and proactive control technology results in enormous energy savings and improved preparation humidity and temperature of the process gas 2. For practical purposes, switching on or switching off the device components 4 significantly lowers the costs for system operation.

The control unit 67 decides which device components 4 of the process gas preparation device 1 to switch on or switch off to dehumidify the process gas 2 based on the absolute humidity comparison. The following presents absolute humidity nominal values used in practice when operating the process gas preparation device 1:
Dehumidification only via the condenser dehumidifier 26 at an absolute humidity nominal value of greater than or equal to 8 g/m³; adsorber dehumidifier 29 if present switched off
Dehumidification only via the adsorber dehumidifier 29 at an absolute humidity nominal value of less than 8 g/m³; condenser dehumidifier 26 if present switched off
Dehumidification via the condenser dehumidifier 26 and via the adsorber dehumidifier 29 at an absolute humidity nominal value of less than 8 g/m³ and a difference between the absolute humidity actual value and absolute humidity nominal value of greater than or equal to 6 g/m³
Humidification via the humidifier 55 for an absolute humidity actual value less than the absolute humidity nominal value.

1. A process gas preparation device for a process gas to treat a process material in a process apparatus, comprising:
a process gas inlet and a process gas outlet fluidly connected with the process apparatus, whereby the process gas flows in a preparation section that extends from the process gas inlet to the process gas outlet,
a process gas dehumidifier designed as a device component in the flow direction of the process gas, and
a process gas tempering device designed as a device component downstream from the process gas dehumidifier, and
a control unit,
wherein the process gas dehumidifier has a dehumidifier inlet and a dehumidifier outlet, and the process gas tempering device has a tempering device inlet and a tempering device outlet,
wherein the process gas tempering device has a tempering unit for the process gas designed as a device component having a tempering unit inlet and a tempering unit outlet, and
wherein a second measurement unit, having a relative humidity sensor to measure the relative humidity of the process gas, is arranged upstream of the process gas dehumidifier.

2. The process gas preparation device according to claim 1, wherein the process gas preparation device has a process apparatus as a device component, wherein the process apparatus is designed as a fluidization apparatus or a coating apparatus.

3. (canceled)

4. (canceled)

5. The process gas preparation device according to claim 1, wherein the process gas dehumidifier has a condenser dehumidifier designed as a device component, having a condenser dehumidifier inlet and a condenser dehumidifier outlet and/or an adsorber dehumidifier designed as a device component, having an adsorber dehumidifier inlet and an adsorber dehumidifier outlet, whereby the condenser dehumidifier is arranged upstream of the adsorber dehumidifier on the preparation section.

6. (canceled)

7. The process gas preparation device according to claim 5, wherein the adsorber dehumidifier has a regeneration unit designed as a device component, having a regeneration unit inlet and a regeneration unit outlet, whereby a regeneration gas is conveyed by a regeneration gas conveyance device designed as a device component, having a regeneration gas conveyance device inlet and a regeneration gas conveyance device outlet on a regeneration section extending from the regeneration unit inlet to the regeneration unit outlet, and flows through a regeneration gas heater designed as a device component, having a regeneration gas heater inlet and regeneration gas heater outlet, and an adsorber dehumidifier having a regeneration gas inlet and a regeneration gas outlet, in the flow direction of the regeneration gas.

8. The process gas preparation device according to claim 7, wherein the regeneration section is designed as a closed loop.

9. The process gas preparation device according to claim 1, wherein the process gas dehumidifier has a preheating unit designed as a device component, having a preheating unit inlet and a preheating unit outlet, which is arranged upstream of the condenser dehumidifier and/or the adsorber dehumidifier.

10. The process gas preparation device according to claim 8, wherein the preheating unit is further assigned to the regeneration unit, whereby the preheating unit is arranged upstream of the regeneration gas heating device and downstream of the regeneration gas conveyance device on the regeneration section designed as a loop, whereby the process gas is heated when flowing through the preheating unit and the regeneration gas is cooled when flowing through the preheating unit.

11. (canceled)

12. The process gas preparation device according to claim 1, wherein the rein the first measurement device is arranged upstream of the process gas tempering device.

13. The process gas preparation device according to claim 1, wherein the first measurement device additionally has a temperature sensor to measure the temperature of the process gas.

14. (canceled)

15. The process gas preparation device according to claim 1, wherein the tempering unit has a heating device designed as a device component, having a heating device inlet and a heating device outlet.

16. (canceled)

17. The process gas preparation device according to claim 1, wherein the process gas tempering unit has a cooling unit for the process gas designed as a device component, having a cooling unit inlet and a cooling unit outlet, and has a bypass unit designed as a device component, having a bypass inlet and a bypass outlet, connected parallel to the tempering unit, whereby a valve arrangement designed as a device component is arranged on the bypass unit for selective flow through the tempering unit or the bypass unit, and is connected to a first measurement device having a relative humidity sensor for measuring the relative humidity of the process gas, whereby the first measurement device is arranged downstream of the process gas dehumidifier.

18. The process gas preparation device according to claim 17, wherein the cooling unit is part of the bypass unit.

19. (canceled)

20. (canceled)

21. The process gas preparation device according to claim 1, wherein the process gas preparation device has a humidifier designed as a device component, having a humidifier inlet and humidifier outlet.

22. A procedure for the preparation of process gas to treat a process material in a process apparatus during a drying phase and a cooling phase, having a process gas preparation device, with a process gas inlet and a process gas outlet fluidly connected with the process apparatus, whereby the process gas streams in a preparation section that extends from the process gas inlet to the process gas outlet, with a process gas dehumidifier designed as a device component in the flow direction of the process gas, and a process gas tempering device designed as a device component downstream from the process gas dehumidifier, whereby the process gas dehumidifier has a dehumidifier inlet and dehumidifier outlet, and the process gas tempering device has a tempering device inlet and a tempering device outlet, and whereby the process gas tempering device has a tempering unit for the process gas designed as a device component having a tempering unit inlet and a tempering unit outlet, and with a control unit, wherein each device component of the process gas preparation device can be switched on and/or switched off, and that a second measurement unit, having a relative humidity sensor to measure the relative humidity of the process gas, is arranged upstream of the process gas dehumidifier.

23. (canceled)

24. (canceled)

25. (canceled)

26. (canceled)

27. (canceled)

28. The procedure according to claim 22, wherein the process gas is humidified by a humidifier.

29. The procedure according to claim 22, wherein the process gas dehumidifier (18) has an adsorber dehumidifier having a regeneration unit, whereby the adsorber dehumidifier is at least partially regenerated by the regeneration unit.

30. The procedure according to claim 29, wherein the regeneration unit has a regeneration gas heating device warming a regeneration gas, so that the regeneration gas absorbs humidity when flowing through the adsorber dehumidifier, by means of which the adsorber dehumidifier is at least partially dried and thereby regenerated.

31. (canceled)

32. The procedure according to claim 22, wherein the process gas dehumidifier has a preheating unit that is arranged upstream of the condenser dehumidifier, whereby the preheating unit warms the process gas entering the process gas preparation device via the process gas inlet, in order to prevent freezing of the condenser dehumidifier or to warm the process gas for the humidification of the process gas.

33. The procedure according to claim 22, wherein the process gas tempering unit has a cooling unit for the process gas designed as a device component, having a cooling unit inlet and a cooling unit outlet, and has a bypass unit designed as a device component, having a bypass inlet and a bypass outlet, connected parallel to the tempering unit, whereby a valve arrangement designed as a device component is arranged on the bypass unit for selective flow through the tempering unit or the bypass unit, and is connected to a first measurement device having a relative humidity sensor for measuring the relative humidity of the process gas, whereby the first measurement device is arranged downstream of the process gas dehumidifier, whereby the cooling unit is a component of the bypass unit, and whereby during treatment of the process material in the process apparatus there is flow through the tempering unit in the drying phase and through the bypass unit that has the cooling unit during the cooling phase.

34. (canceled)

35. (canceled)

36. (canceled)

37. (canceled)
